(19) United States
(12) Patent Application Publication
(10) Pub. No.: US 2017/0279686 A1
(43) Pub. Date: Sep. 28, 2017

(54) Terminal Topology Management Service Method, Device, and System for Internet of Things

(71) Applicant: ZTE CORPORATION, Shenzhen City, Guangdong (CN)

(72) Inventor: Weixiang SHAO, Shenzhen (CN)

(21) Appl. No.: 15/326,038

(22) PCT Filed: Mar. 13, 2015
(86) PCT No.: PCT/CN2015/074253

§ 371 Date: Jun. 7, 2017

(30) Foreign Application Priority Data
Jul. 18, 2014 (CN) 201410345943.8

(51) Int. Cl. H04L 12/24; H04L 29/08

(52) U.S. Cl. CPC H04L 41/12; H04L 67/12

(57) ABSTRACT

A terminal topology management service method, apparatus and system for Internet of things are provided. The method includes: receiving a management operation or capability of a terminal topology management service requested by an application entity, managing a requested target terminal according to the management operation or capability of the terminal topology management service; and providing an operation result and/or an operation status for the application entity. The present document realizes uniform management of terminal topologies.

### TECHNICAL FIELD

The present document relates to the field of communications, and in particular to a terminal topology management service method, apparatus and system for Internet of things.

### BACKGROUND

The Internet of things is an important part of the new generation of information technology, and its English name is ‘The Internet of things’. Just as its name implies, the Internet of things is an Internet over which things are connected with each other. According to the ITU Internet Report released by the International Telecommunication Union (ITU), the Internet of things is defined as follows: the Internet of things is a network which connects, according to an agreed protocol, any object with the Internet through information sensing devices including two-dimensional identification devices, Radio Frequency Identification Devices (RFIDs), infrared sensors, global positioning systems and laser scanners to realize information exchange and communication so as to achieve intelligent identification, positioning, tracking, monitoring and management.

The concept of M2M, which can be explained as Man to Man, Man to Machine, or Machine to Machine, is often introduced into the Internet of things. Essentially, most of man-to-machine interactions and machine-to-machine interactions aim at achieving the information interactions of men. M2M network, which is the main presentation form of the Internet of things at the present stage, includes machine-to-machine communication network, man-to-machine communication network and machine-to-man communication network. The devices of an M2M network mainly include an M2M terminal, an M2M gateway and an M2M server.

FIG. 1 is a schematic diagram illustrating a system of Internet of things according to the related technology, and as shown in FIG. 1, the Internet of things can be classified into private Internet of things (generally providing services for the interior of a single organization), public Internet of things (providing services for the public or a large user groups based on the Internet), and communal Internet of things (providing services for an associated “community” or organizational group). The Internet of things is currently applied widely in different industries including intelligent agriculture, smart power grids, intelligent transportation systems, intelligent logistics, intelligent medical treatments and smart homes, etc. Particularly, professional Internet of things that is separately deployed in these industries includes corresponding professional Internet of things/M2M devices such platform devices as terminal, gateway and other platform devices, etc.

As public communication service providers, telecom operators play the role of providers of public Internet of things when providing Internet of things/M2M services. At present stage, as providers of public Internet of things, telecom operators lack an effective technical means in uniformly managing the terminals of private Internet of things, communal Internet of things and other professional Internet of things that are used in different industries and realizing the services of these terminals.

### SUMMARY

Embodiments of the present document provide a terminal topology management service method, apparatus and system for Internet of things, so as to solve at least the problem existing in the related technology that telecom operators, as providers of public Internet of things, are incapable of uniformly managing the terminals in domains of public Internet of things and other Internet of things.

An aspect of the embodiments of the present document provides a terminal topology management service method for Internet of things. The method includes: receiving a management operation or capability of a terminal topology management service requested by an application entity, and managing a requested target terminal according to the management operation or capability of the terminal topology management service; and providing an operation result and/or an operation status for the application entity.

Alternatively, the target terminal includes one of the following: a single terminal, a plurality of terminals in a list and a terminal group.

Alternatively, the management operation or capability of the terminal topology management service is executed based on a scheduling arrangement.

Alternatively, a message exchange mode used by the management operation or capability of the terminal topology management service includes one of the following: a request response mode of receiving a request and sending a response synchronously; and a request asynchronization notification mode of reporting to the application entity after the operation is completed.

Alternatively, the management operation or capability of the terminal topology management service includes: acquiring all M2M area networks; herein returned information of the acquired M2M area networks includes at least one of the following: a response type, and an M2M area network list; the M2M area network list includes one or more M2M area networks; and the M2M area network includes at least one of the following contents: an M2M area network identifier, an M2M area network name, an M2M area network type, a terminal list, and a transmission protocol.

Alternatively, the management operation or capability of the terminal topology management service includes: creating an M2M area network; herein input information of the created M2M area network includes at least one of the following: an M2M area network name, an M2M area network type, and a transmission protocol; herein returned information of the created M2M area network includes at least one of the following: a response type, an M2M area network identifier, and creation time.

Alternatively, the management operation or capability of the terminal topology management service includes: deleting an M2M area network; herein input information of the deleted M2M area network include an M2M area network identifier; herein returned information of the deleted M2M area network includes a response type.

Alternatively, the management operation or capability of the terminal topology management service includes: modifying an M2M area network; herein input information of the modified M2M area network includes at least one of the following: an M2M area network identifier, a modified M2M area network name, a modified M2M area network type, and a modified transmission protocol; herein returned information of the modified M2M area network includes at least one of the following: a response type, and modification time.

Alternatively, the management operation or capability of the terminal topology management service includes: acquiring a terminal of an M2M area network; herein input information of the acquired terminal of the M2M area network includes at least one of the following: an M2M area network identifier, and a terminal identifier; herein returned information of the acquired terminal of the M2M area network includes at least one of the following: a response type, and information of the terminal of the M2M area network; and the information of the terminal of the M2M area network includes at least one of the following contents: a terminal type, a sleep interval time, a sleep time duration, a sleep or awake state of the terminal, and a neighbor list.

Alternatively, the management operation or capability of the terminal topology management service includes: adding a terminal in an M2M area network; herein input information of the added terminal of the M2M area network includes at least one of the following: an M2M area network identifier, and a terminal identifier; herein returned information of the added terminal of the M2M area network includes at least one of the following: a response type, and modification time.

Alternatively, the management operation or capability of the terminal topology management service includes: deleting a terminal from an M2M area network; herein input information of the deleted terminal of the M2M area network includes at least one of the following: an M2M area network identifier, and a terminal identifier; herein returned information of the deleted terminal of the M2M area network includes at least one of the following: a response type.

Alternatively, the management operation or capability of the terminal topology management service includes: modifying a terminal in an M2M area network; herein input information of the modified terminal of the M2M area network includes at least one of the following: an M2M area network identifier, a terminal identifier, and modified information of the terminal of the M2M area network; the modified information of the terminal of the M2M area network includes at least one of the following contents: a modified terminal type, a modified sleep interval time, a modified sleep time duration, a modified sleep or awake state of the terminal, and a modified neighbor list; herein returned information of the modified terminal of the M2M area network includes at least one of the following: a response type, and modification time.

Alternatively, receiving a management operation or capability of a terminal topology management service requested by an application entity further includes: adapting the management operation or capability of the terminal topology management service to a technical operation corresponding to a terminal management server.

Alternatively, the terminal management server includes: a terminal management server located on a bottom layer network of a public Internet of things or a terminal management server located in a domain of another service provider.

Alternatively, the terminal management server uses at least one of the following technologies: an Extensible Messaging and Presence Protocol (XMPP), a Message Queuing Telemetry Transport (MQTT), an Open Mobile Alliance Device Management (OMA DM), a Broadband Forum CPE WAN Management (BBF CWMP), and an Open Mobile Alliance LightweightM2M (OMA LightweightM2M).

In accordance with another aspect of the embodiments of the present document, a terminal topology management service apparatus for Internet of things is provided. The apparatus includes a management module and a feedback module. The management module receives a management operation or capability of a terminal topology management service requested by an application entity, and manages a requested target terminal according to the management operation or capability of the terminal topology management service. The feedback module provides an operation result and/or an operation status for the application entity.

Alternatively, the target terminal includes one of the following: a single terminal, a plurality of terminals in a list and a terminal group.

Alternatively, the management operation or capability of the terminal topology management service is executed based on a scheduling arrangement.

Alternatively, the management module adapts the management operation or capability of the terminal topology management service to a technical operation corresponding to a terminal management server.

Alternatively, the terminal management server includes: a terminal management server located on a bottom layer network of a public Internet of things or a terminal management server located in a domain of another service provider.

In accordance with still another aspect of the embodiments of the present document, a terminal topology management service system for Internet of things is provided. The system includes an application entity and a common service entity. The application entity requests a management operation or capability of a terminal topology management service. The common service entity receives the management operation or capability of the terminal topology management service requested by the application entity, manages a requested target terminal according to the management operation or capability of the terminal topology management service; and provides an operation result and/or an operation status for the application entity.

Alternatively, the above-mentioned system further includes a management adaptor. The management adaptor adapts the management operation or capability of the terminal topology management service to a technical operation corresponding to a terminal management server.

The present document realizes a uniform management on terminal topologies, by receiving a management operation or capability of a terminal topology management service requested by an application entity, managing a requested target terminal according to the management operation or capability of the terminal topology management service and providing an operation result and/or an operation status for the application entity.

### BRIEF DESCRIPTION OF DRAWINGS

The accompanying drawings described herein which are incorporated into and form a part of the application are provided for the further understanding of the present document, and illustrative embodiments of the present document and the description thereof are used to explain the present document but are not to be construed as improper limitations to the present document. In the accompanying drawings:

FIG. 1 is a schematic diagram illustrating a system of Internet of things according to the related technology;

FIG. 2 is a flowchart illustrating a terminal topology management service method for Internet of things according to an embodiment of the present document;

FIG. 3 is a block diagram illustrating a structure of a terminal topology management service apparatus for Internet of things according to an embodiment of the present document;

FIG. 4 is a schematic diagram illustrating a terminal topology management service system for Internet of things according to an embodiment of the present document;

FIG. 5 is a flowchart illustrating an alternative terminal topology management service method one for Internet of things according to an embodiment of the present document; and

FIG. 6 is a flowchart illustrating an alternative terminal topology management service method two for Internet of things according to an embodiment of the present document.

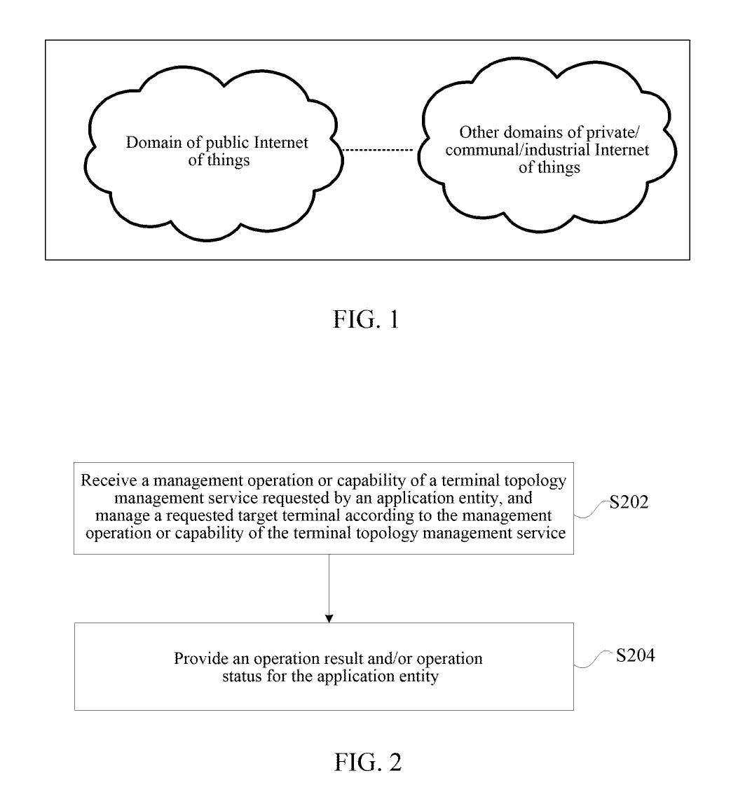

### DETAILED DESCRIPTION

The present document will be described below in detail with reference to accompanying drawings when read in conjunction with alternative embodiments. It should be illustrated that the embodiments of the present document and the features thereof can be combined with each other if no conflict is caused.

The common service entity and the application entity involved in the following embodiments can be understood with reference to Patent Application No. 201410127388.1, entitled ‘M2M application service method, apparatus and system’ and are therefore not described here repeatedly.

In the following embodiments, an M2M terminal may be a mobile terminal (e.g. mobile phone, tablet personal computer and so on), or may be any other type of terminal that can access the Internet of things. The operating system running on the terminal may also be any type of system, for example, the android system which is being widely used at present, the Windows operating system, the iOS system and so on, but there is no limit to the above systems. A device may be a server, any type of gateway or other types of device different from server and gateway.

The terminal or device may include a storage medium in which a program unit is stored that can be used to execute the methods described in the following embodiments. The terminal or device may further include a processor which executes the above-mentioned program unit. It can be expected that the methods or apparatuses described below can be realized by program units.

Other internet-of-things domains mentioned in the following embodiments may refer to a private internet of things that is provided for the interior of a single organization, other public internets of things and communal internets of things. Other internet-of-things domains may also refer to a wide application of the internet of things in different industries including intelligent agriculture, smart power grids, intelligent transportation systems, intelligent logistics, intelligent medical treatments and smart homes, etc.

FIG. 2 is a flowchart illustrating a terminal topology management service method for Internet of things according to an embodiment of the present document, and as shown in FIG. 2, the method includes steps S202-S204.

In step S202: a management operation or capability of a terminal topology management service requested by an application entity is received, and a requested target terminal is managed according to the management operation or capability of the terminal topology management service.

In step S204: an operation result and/or operation status is/are provided for the above-mentioned application entity.

By receiving a management operation or capability of a terminal topology management service requested by an application entity, managing a requested target terminal according to the management operation or capability of the terminal topology management service and providing an operation result and/or an operation status for the application entity, the embodiment of the present document realizes the uniform management of terminal topologies.

In an implementation of embodiments of the present document, the above-mentioned target terminal includes one of the following terminals: a single terminal, a plurality of terminals in a list and a terminal group.

Alternatively, the management operation or capability of the above-mentioned terminal topology management service is executed based on a scheduling arrangement.

In an implementation of embodiments of the present document, the message exchange mode adopted by the management operation or capability of the above-mentioned terminal topology management service includes one of the following modes: a request response mode of receiving a request and sending a response synchronously, and a request asynchronization notification mode of reporting to the application entity after the operation is completed.

In an implementation of embodiments of the present document, the management operation or capability of the above-mentioned terminal topology management service includes acquiring all M2M area networks. Herein the returned information of the above-mentioned acquired M2M area networks includes at least one of the following contents: a response type, and an M2M area network list which includes one or more M2M area networks, and the above-mentioned M2M area network includes at least one of the following contents: an M2M area network identifier, an M2M area network name, an M2M area network type, a terminal list, and a transmission protocol.

In an implementation of embodiments of the present document, the management operation or capability of the above-mentioned terminal topology management service includes creating an M2M area network. Herein the input information of the above-mentioned created M2M area network includes at least one of the following: an M2M area network name, an M2M area network type, and a transmission protocol. Herein the returned information of the above-mentioned created M2M area network includes at least one of the following: a response type, an M2M area network identifier, and creation time.

In an implementation of embodiments of the present document, the management operation or capability of the above-mentioned terminal topology management service includes deleting an M2M area network. Herein the input information of the above-mentioned deleted M2M area network includes an M2M area network identifier. Herein the returned information of the above-mentioned deleted M2M area network includes a response type.

In an implementation of embodiments of the present document, the management operation or capability of the above-mentioned terminal topology management service includes modifying M2M area network. Herein the input information of the above-mentioned modified M2M area network includes at least one of the following: an M2M area network identifier, a modified M2M area network name, a modified M2M area network type, and a modified transmission protocol. The returned information of the above-mentioned modified M2M area network includes at least one of the following: a response type, and a modification time.

In an implementation of embodiments of the present document, the management operation or capability of the above-mentioned terminal topology management service includes acquiring a terminal of an M2M area network. Herein the input information of the above-mentioned acquired terminal of the M2M area network includes at least one of the following: an M2M area network identifier, and a terminal identifier. The returned information of the above-mentioned acquired terminal of the M2M area network includes at least one of the following: a response type, and the information of the terminal of the M2M area network. The information of the terminal of the above-mentioned M2M area network includes at least one of the following contents: a terminal type, a sleep interval time, a sleep time duration, a sleep or awake state of the terminal, and a neighbor list.

In an implementation of embodiments of the present document, the management operation or capability of the above-mentioned terminal topology management service includes adding a terminal of an M2M area network. Herein the input information of the above-mentioned added terminal of the M2M area network includes at least one of the following: an M2M area network identifier, and a terminal identifier, and the returned information of the above-mentioned added terminal of the M2M area network includes at least one of the following: a response type, and modification time.

In an implementation of embodiments of the present document, the management operation or capability of the above-mentioned terminal topology management service includes deleting a terminal of an M2M area network. Herein the input information of the above-mentioned deleted terminal of the M2M area network includes at least one of the following: an M2M area network identifier, and a terminal identifier, and the returned information of the above-mentioned deleted terminal of the M2M area network includes at least one of the following: a response type.

In an implementation of embodiments of the present document, the management operation or capability of the above-mentioned terminal topology management service includes modifying a terminal of an M2M area network. Herein the input information of the above-mentioned modified terminal of the M2M area network includes at least one of the following: an M2M area network identifier, a terminal identifier, and modified information of the terminal of the M2M area network. The above-mentioned modified information of the terminal of the M2M area network includes at least one of the following contents: a modified terminal type, a modified sleep interval time, a modified sleep time duration, a modified sleep or awake state of the terminal, and a modified neighbor list. The returned information of the above-mentioned modified terminal of the M2M area network includes at least one of the following: a response type, and modification time.

Alternatively, receiving a management operation or capability of a terminal topology management service requested by an application entity further includes: adapting the management operation or capability of the above-mentioned terminal topology management service to a technical operation corresponding to a terminal management server.

In an implementation of embodiments of the present document, the terminal management server includes a terminal management server located on a bottom layer network of a public Internet of things or a terminal management server located in a domain of another service provider.

In an implementation of embodiments of the present document, the above-mentioned terminal management server uses at least one of the following technologies: the XMPP, the MQTT, the OMA DM, the BBF CWMP and the OMA LightweightM2M.

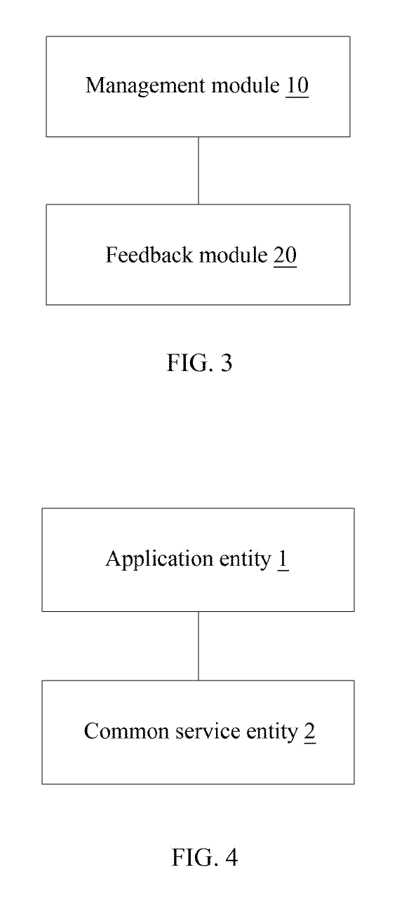

FIG. 3 is a block diagram illustrating the structure of a terminal topology management service apparatus for Internet of things according to an embodiment of the present document. As shown in FIG. 3, the apparatus includes a management module 10 and a feedback module 20. The management module 10 receives a management operation or capability of a terminal topology management service requested by an application entity and manages a requested target terminal according to the above-mentioned management operation or capability of the terminal topology management service. The feedback module 20 provides an operation result and/or an operation status for the application entity.

Alternatively, the above-mentioned target terminal includes one of the following terminals: a single terminal, a plurality of terminals in a list and a terminal group.

Alternatively, the above-mentioned management operation or capability of the terminal topology management service is executed based on a scheduling arrangement.

Alternatively, the above-mentioned management module 10 adapts the management operation or capability of the above-mentioned terminal topology management service to a technical operation corresponding to a terminal management server.

Alternatively, the above-mentioned terminal management server includes: a terminal management server on the bottom layer network of a public internet of things or a terminal management server in the domain of other service provider.

It should be illustrated that the parts of the above-mentioned apparatus corresponding to the above-mentioned method can be understood with reference to the description of the above-mentioned method and are therefore not described here repeatedly.

FIG. 4 is a schematic diagram illustrating a terminal topology management service system for Internet of things according to an embodiment of the present document. As shown in FIG. 4, the system includes an application entity 1 and a common service entity 2. The application entity 1 requests a management operation or capability of a terminal topology management service. A common service entity 2 receives the management operation or capability of the terminal topology management service requested by the application entity, manages a requested target terminal according to the above-mentioned management operation or capability of the terminal topology management service, and provides an operation result and/or an operation status for the application entity.

Alternatively, the above-mentioned system further includes a management adaptor. The management adaptor adapts the management operation or capability of the terminal topology management service to a technical operation corresponding to a terminal management server.

It should be illustrated that the parts of the above-mentioned system corresponding to the above-mentioned method can be understood with reference to the description of the above-mentioned method and are therefore not described here repeatedly.

The specific implementation is described below in detail with reference to instances, and it is predicable that the specific implementation is not limited to the following methods. The specific structure of the common service entity involved in the following implementation can be understood with reference to Patent Application No. 201410127388.1, entitled ‘M2M application service method, apparatus and system’ and is therefore not described here repeatedly.

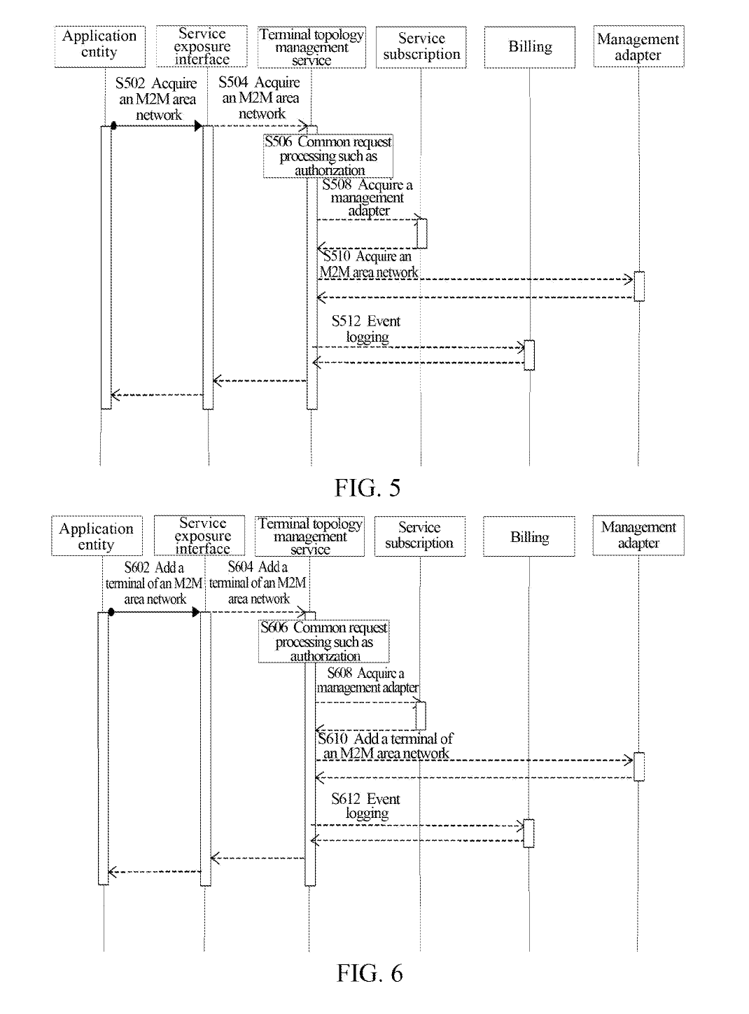

FIG. 5 is a flowchart illustrating an alternative terminal topology management service method one for Internet of things according to an embodiment of the present document. As shown in FIG. 5, the method includes steps S502-S512.

In step S502: an application entity sends an M2M area network acquisition request to the service exposure interface of a terminal topology management service.

In step S504: the service exposure interface forwards the M2M area network acquisition request to the terminal topology management service.

In step S506: the terminal topology management service calls a common request processing such as authorization.

In step S508: the terminal topology management service acquires a management adapter through a service subscribing relation.

In step S510: the terminal topology management service sends the M2M area network acquisition request to the management adapter. The management adapter subsequently calls a terminal management server located on the bottom layer network of a public Internet of things or a terminal management server located in the domain of another service provider. The terminal management server may use at least of the following technologies: the Extensible Messaging and Presence Protocol (XMPP), the Message Queuing Telemetry Transport (MQTT), the Open Mobile Alliance Device Management (OMA DM), the Broadband Forum CPE WAN Management (BBF CWMP) and the Open Mobile Alliance LightweightM2M (OMA LightweightM2M).

In step S512: the terminal topology management service carries out event logging.

FIG. 6 is a flowchart illustrating an alternative terminal topology management service method two for the Internet of things according to an embodiment of the present document. As shown in FIG. 6, the method includes steps S602-S612.

In step S602: an application entity sends an M2M area network terminal addition request to the service exposure interface of a terminal topology management service.

In step S604: the service exposure interface forwards the M2M area network terminal addition request to the terminal topology management service.

In step S606: the terminal topology management service calls a common request processing such as authorization.

In step S608: the terminal topology management service acquires a management adapter through a service subscribing relation.

In step S610: the terminal topology management service sends the M2M area network terminal addition request to the management adapter. The management adapter subsequently calls a terminal management server located on the bottom layer network of a public Internet of things or a terminal management server located in the domain of another service provider. The terminal management server may use at least of the following technologies: the Extensible Messaging and Presence Protocol (XMPP), the Message Queuing Telemetry Transport (MQTT), the Open Mobile Alliance Device Management (OMA DM), the Broadband Forum CPE WAN Management (BBF CWMP) and the Open Mobile Alliance LightweightM2M (OMA LightweightM2M).

In step S612: the terminal topology management service carries out event logging.

It can be seen from the above-mentioned description that the present document realizes the following technical effect: the present document addresses the problem in the uniform management of M2M terminals of public internets of things and other internets of things and realizes a uniform topology management service for M2M terminals of public internets of things and other internets of things.

Apparently, it should be understood by those skilled in the art that each module or step described above in the present document can be realized by a universal computing device and that the modules or steps may be integrated on a single computing device or distributed on a network consisting of a plurality of computing devices. Alternatively, the modules or steps may be realized by executable program codes so that the modules or steps can be stored in a memory to be executed by a computing device, and in some cases, the steps shown or described herein can be executed in a sequence different from those presented herein, or the modules or steps are formed into various integrated circuit modules, or a plurality of the modules or steps of them are formed into single integrated circuit modules. Therefore, the present document is not limited to the combination of any specific hardware and software.

Although certain alternative embodiments of the present document have been described above, it should be understood that the alternative embodiments are not described for limiting the present document and that a variety of modifications and variations can be devised by those of ordinary skill in the art. Any modification, equivalent substitute and improvement that can be devised by those of ordinary skill in the art without departing from the spirit of the present document and that the modifications and improvements shall fall within the protection scope of the present document.

### INDUSTRIAL APPLICABILITY

As stated above, the embodiments of the present document provide a terminal topology management service method, apparatus and system for Internet of things which have the following beneficial effects: realizing a uniform topology management service for the M2M terminals of public Internet of things and other Internet of things, by receiving a management operation or capability of a terminal topology management service requested by an application entity, managing a requested target terminal according to the management operation or capability of the terminal topology management service, and providing an operation result and/or an operation status for the application entity.

What is claimed is:

1. A terminal topology management service method for Internet of things, comprising:
receiving a management operation or capability of a terminal topology management service requested by an application entity, and managing a requested target terminal according to the management operation or capability of the terminal topology management service;
providing an operation result and/or an operation status for the application entity.

2. The method according to claim 1, wherein the target terminal comprises one of the following: a single terminal, a plurality of terminals in a list, and a terminal group.

3. The method according to claim 1, wherein the management operation or capability of the terminal topology management service is executed based on a scheduling arrangement.

4. The method according to claim 1, wherein a message exchange mode used by the management operation or capability of the terminal topology management service comprises one of the following:
a request response mode of receiving a request and sending a response synchronously; and
a request asynchronization notification mode of reporting to the application entity after the operation is completed.

5. The method according to claim 1, wherein the management operation or capability of the terminal topology management service comprises: acquiring all M2M area networks; wherein
returned information of the acquired M2M area networks comprises at least one of the following: a response type, and an M2M area network list;
the M2M area network list comprises one or more M2M area networks; and
the M2M area network comprises at least one of the following contents: an M2M area network identifier, an M2M area network name, an M2M area network type, a terminal list, and a transmission protocol.

6. The method according to claim 1, wherein the management operation or capability of the terminal topology management service comprises: creating an M2M area network; wherein
input information of the created M2M area network comprises at least one of the following: an M2M area network name, an M2M area network type, and a transmission protocol; and
returned information of the created M2M area network comprises at least one of the following: a response type, an M2M area network identifier, and creation time.

7. The method according to claim 1, wherein the management operation or capability of the terminal topology management service comprises: deleting an M2M area network; wherein
input information of the deleted M2M area network comprises an M2M area network identifier; and
returned information of the deleted M2M area network comprises a response type.

8. The method according to claim 1, wherein the management operation or capability of the terminal topology management service comprises: modifying an M2M area network; wherein
input information of the modified M2M area network comprises at least one of the following: an M2M area network identifier, a modified M2M area network name, a modified M2M area network type, and a modified transmission protocol; and
returned information of the modified M2M area network comprises at least one of the following: a response type, and modification time.

9. The method according to claim 1, wherein the management operation or capability of the terminal topology management service comprises: acquiring a terminal of an M2M area network; wherein
input information of the acquired terminal of the M2M area network comprises at least one of the following: an M2M area network identifier, and a terminal identifier;
returned information of the acquired terminal of the M2M area network comprises at least one of the following: a response type, and information of the terminal of the M2M area network; and
the information of the terminal of the M2M area network comprises at least one of the following contents: a terminal type, a sleep interval time, a sleep time duration, a sleep or awake state of the terminal, and a neighbor list.

10. The method according to claim 1, wherein the management operation or capability of the terminal topology management service comprises: adding a terminal of an M2M area network; wherein
input information of the added terminal of the M2M area network comprises at least one of the following: an M2M area network identifier, and a terminal identifier; and
returned information of the added terminal of the M2M area network comprises at least one of the following: a response type, and modification time.

11. The method according to claim 1, wherein the management operation or capability of the terminal topology management service comprises: deleting a terminal of an M2M area network; wherein
input information of the deleted terminal of the M2M area network comprises at least one of the following: an M2M area network identifier, and a terminal identifier; and
returned information of the deleted terminal of the M2M area network comprises at least one of the following: a response type.

12. The method according to claim 1, wherein the management operation or capability of the terminal topology management service comprises: modifying a terminal of an M2M area network; wherein
input information of the modified terminal of the M2M area network comprises at least one of the following: an M2M area network identifier, a terminal identifier, and modified information of the terminal of the M2M area network;
the modified information of the terminal of the M2M area network comprises at least one of the following contents: a modified terminal type, a modified sleep interval time, a modified sleep time duration, a modified sleep or awake state of the terminal, and a modified neighbor list; and
returned information of the modified terminal of the M2M area network comprises at least one of the following: a response type, and modification time.

13. The method according to claim 1, wherein receiving a management operation or capability of a terminal topology management service requested by an application entity further comprises:
adapting the management operation or capability of the terminal topology management service to a technical operation corresponding to a terminal management server.

14. The method according to claim 13, wherein the terminal management server comprises: a terminal management server located on a bottom layer network of a public Internet of things or a terminal management server located in a domain of another service provider.

15. The method according to claim 13, wherein the terminal management server uses at least one of the following technologies: an Extensible Messaging and Presence Protocol (XMPP), a Message Queuing Telemetry Transport (MQTT), an Open Mobile Alliance Device Management (OMA DM), a Broadband Forum CPE WAN Management (BBF CWMP), and an Open Mobile Alliance LightweightM2M (OMA LightweightM2M).

16. A terminal topology management service apparatus for Internet of things, comprising a management module and a feedback module,
the management module receiving a management operation or capability of a terminal topology management service requested by an application entity, and managing a requested target terminal according to the management operation or capability of the terminal topology management service; and
the feedback module providing an operation result and/or an operation status for the application entity.

17. The apparatus according to claim 16, wherein the target terminal comprises one of the following: a single terminal, a plurality of terminals in a list, and a terminal group;
and wherein the management operation or capability of the terminal topology management service is executed based on a scheduling arrangement.

18. (canceled)

19. The apparatus according to claim 16, wherein the management module adapts the management operation or capability of the terminal topology management service to a technical operation corresponding to a terminal management server; and
wherein the terminal management server comprises: a terminal management server located on a bottom layer network of a public Internet of things or a terminal management server located in a domain of another service provider.

20. (canceled)

21. A terminal topology management service system for Internet of things, comprising an application entity and a common service entity,
the application entity requesting a management operation or capability of a terminal topology management service; and
the common service entity receiving the management operation or capability of the terminal topology management service requested by the application entity, and managing a requested target terminal according to the management operation or capability of the terminal topology management service; and providing an operation result and/or an operation status for the application entity.

22. The system according to claim 21, further comprising a management adapter,
wherein the management adapter adapts the management operation or capability of the terminal topology management service to a technical operation corresponding to a terminal management server.
